(19) United States
(12) Patent Application Publication
(10) Pub. No.: US 2011/0235080 A1
(43) Pub. Date: Sep. 29, 2011

(54) IMAGE PROCESSING APPARATUS AND IMAGE FORMING APPARATUS

(75) Inventors: Kunikazu SATOU, Tokyo (JP); Fumihito Akiyama, Yokohama-shi (JP); Masahiro Ozawa, Tokyo (JP); Jun Kuroki, Superior, CO (US); Takahisa Matsunaga, Tokyo (JP); Hiroshi Nogawa, Tokyo (JP); Yasufumi Aoyama, Tokyo (JP); Yasutaka Shimohara, Tokyo (JP)

(73) Assignee: Konica Minolta Business Technologies, Inc., Chiyoda-ku (JP)

(21) Appl. No.: 13/014,035

(22) Filed: Jan. 26, 2011

(30) Foreign Application Priority Data
Jan. 29, 2010 (JP) 2010-017531

(51) Int. Cl. G06K 15/00

(52) U.S. Cl. 358/1.13

(57) ABSTRACT

Disclosed is an image processing apparatus including: a control section including a plurality of computing sections, each of the plurality of computing sections to perform language analyzing processing to perform language analysis on PDL data to generate a display list of an object, drawing processing to rasterize an object of the display list, and combining processing to combine data of the rasterized object, to generate printable data based on the PDL data, wherein each of the plurality of computing sections is set to any one of two or more resolutions for rasterizing; the rasterizing in the drawing processing is performed parallel in each of the computing sections at the resolutions set in each computing section; and the combining processing enlarges the data of the rasterized object of a low resolution to the highest resolution and combines the data.

### CROSS-REFERENCE TO RELATED APPLICATIONS

The present U.S. patent application claims priority under the Paris Convention of Japanese Patent Application No. 2010-017531 filed on Jan. 29, 2010 to the Japanese Patent Office, which shall be a basis for correcting mistranslations.

### BACKGROUND

1. Field of the Invention

The present invention relates to an image processing apparatus and an image forming apparatus.

2. Description of Related Art

Conventionally, an image forming apparatus such as an MFP (Multi-Function Peripheral), printer, etc. is well known. Lately, in an image forming apparatus, there is a rising demand for high definition printing. In response to this demand, there is known a technique in image processing of print data in which a text/line object subject to edge enhancement is rasterized at a raised resolution, and then combined with an image object.

Here, the operation when such image processing technique is realized in a single core CPU (Central Processing Unit) is described. Single core is a structure in which there is one processor core in one CPU package. FIG. 19 shows a ladder chart of language analyzing processing, drawing processing, and combining processing performed in a conventional CPU of an image forming apparatus.

The following example describes printing print data including an (drawing) object 1 other than a text/line object and an object 2 which is a text/line object in a first band of the first page in an image forming apparatus including a single core CPU. This image forming apparatus is compliant to PDL (Page Description Language). A band (area) represents each area when a page of a print image is divided into a plurality of band shaped areas.

First, the CPU of the image forming apparatus receives print data from a PC (Personal Computer) 50 as an external input apparatus. Then, the CPU performs language analysis (page analysis) of the first page of the print data, which is received PDL data, to generate an intermediate language display list (hereinafter referred to as DL: display list) and the DL is stored in the RAM (Random Access Memory). Objects 1, 2 and so on are included in the DL of the first band.

Then, as drawing processing, the CPU reads out the DL from the RAM and rasterizes object 1 of the first band at 600 dpi (low resolution). Then, as combining processing, the CPU copies the object 1 after rasterizing to the area of the first band of the RAM. Then, as drawing processing, the CPU reads out the DL from the RAM and rasterizes object 2 of the first band at 1200 dpi (high resolution). Then, as combining processing, the CPU combines the rasterized object 2 to object 1 in the area of the first band in the RAM, generates printable data and stores the data in the RAM.

In this way, after the CPU stores a page of printable data in the RAM, the image forming section prints the page of printable data. However, when image processing including language analysis, drawing processing and combining processing is realized in a single core CPU, the image processing consumes a long period of time.

Also, there is known an image forming apparatus which uses a plurality of processors. For example, there is an image forming apparatus in which a processor is assigned to each page to perform processing such as a first processor processes a first page of the print data, a second processor processes a second page and so on (for example, Japanese Patent Application Laid-Open Publication No. H5-201077).

Also, there is known an image forming apparatus which uses a multi-core CPU. Multi-core is a structure in which there are a plurality of processor cores in one CPU package. For example, there is an image forming apparatus of a multithread format which uses a multi-core CPU and assigns language analyzing processing, rasterizing processing, image compression processing, data transfer, etc. to each core (for example, Japanese Patent Application Laid-Open Publication No. 2009-116450).

However, in a conventional image forming apparatus using a plurality of processors, when a page is assigned to each processor, for example, there is a possibility that processing of a second page finishes before a first page and the order of output becomes different.

Moreover, in a conventional image forming apparatus using a multi core CPU, the core for image compression and the core for data transfer do not operate until the rasterizing is finished, and efficiency cannot be achieved. In addition, the core for language processing does not operate after the language processing is finished, and efficiency cannot be achieved.

Further, in a conventional image forming apparatus using a multi-core CPU, there is a demand for rasterizing with different resolutions according to the object and combining the object.

### SUMMARY

The present invention has been made in consideration of the above problems, and it is one of main objects to perform image processing of PDL data at a high speed and to realize forming an image with high definition.

An image processing apparatus reflecting one aspect of the present invention includes:

a control section including a plurality of computing sections, each of the plurality of computing sections to perform language analyzing processing to perform language analysis on PDL data to generate a display list of objects, drawing processing to rasterize the objects of the display list, and combining processing to combine data of the rasterized objects, to generate printable data based on the PDL data, wherein

each of the plurality of computing sections is set to any one of two or more resolutions for rasterizing;

the rasterizing in the drawing processing is performed parallel in each of the computing sections at the resolutions set in each computing section; and

the combining processing enlarges the data of the rasterized object of a low resolution to the highest resolution and combines the data.

Preferably, in the image processing apparatus, the control section performs managing processing in which one of the plurality of computing sections manages performing of the language analyzing processing, the drawing processing and the combining processing.

Preferably, in the image processing apparatus, a text/line object is rasterized at a high resolution and an object other than a text/line object is rasterized at a low resolution in the drawing processing.

Preferably, in the image processing apparatus, pieces of data of the objects which are rasterized at the respective resolutions are combined one another in an order of overlapping in the combining processing.

An image forming apparatus reflecting one aspect of the present invention includes:

the above image processing apparatus; and

an image forming section to perform image forming on a sheet according to printable data generated by the drawing processing.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a block diagram showing a functional configuration of an image forming apparatus of the first embodiment of the present invention;

FIG. 2 is a ladder chart showing language analyzing processing, drawing processing and combining processing performed in a core of the image forming apparatus of the first embodiment;

FIG. 3 is a diagram showing an example of combining processing performed in a preferable combining order;

FIG. 4 is a diagram showing an example of combining processing performed in a wrong combining order;

FIG. 5 is a diagram showing an example of combining processing using a band area in which a resolution of an object is different in each core;

FIG. 6 is a diagram showing an example of combining processing using a band area in which a resolution of an object is mixed in each core;

FIG. 7 is a flowchart showing a language analyzing processing;

FIG. 8 is a flowchart showing a first drawing processing;

FIG. 9 is a flowchart showing a second drawing processing;

FIG. 10 is a flowchart showing a first combining processing;

FIG. 11 is a block diagram showing a functional configuration of an image forming apparatus of the second embodiment of the present invention;

FIG. 12 is a ladder chart showing language analyzing processing, drawing processing and combining processing performed in a core of the image forming apparatus of the second embodiment;

FIG. 13 is a flowchart showing a third drawing processing;

FIG. 14 is a flowchart showing a fourth drawing processing;

FIG. 15 is a flowchart showing a second combining processing;

FIG. 16 is a flowchart showing a managing processing;

FIG. 17 is a block diagram showing a functional configuration of an image forming apparatus of the third embodiment of the present invention;

FIG. 18 is a ladder chart showing a language analyzing processing, drawing processing and combining processing performed in a core of the image forming apparatus of the third embodiment; and

FIG. 19 is a ladder chart showing a language analyzing processing, drawing processing and combining processing performed in a CPU of a conventional image forming apparatus.

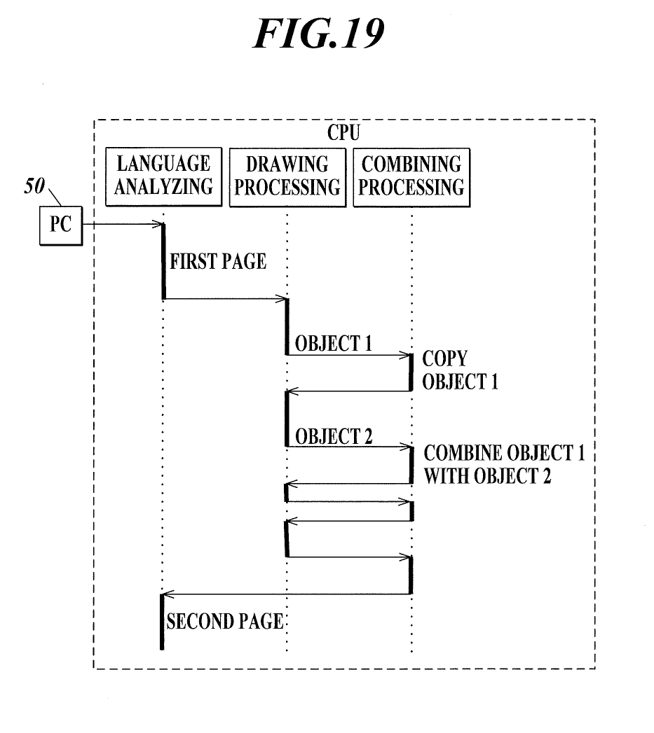

### DETAILED DESCRIPTION OF PREFERRED EMBODIMENTS

The first to third embodiments of the present invention is described in detail in order with reference to the attached drawings. However, the present invention is not limited to the illustrated examples.

### First Embodiment

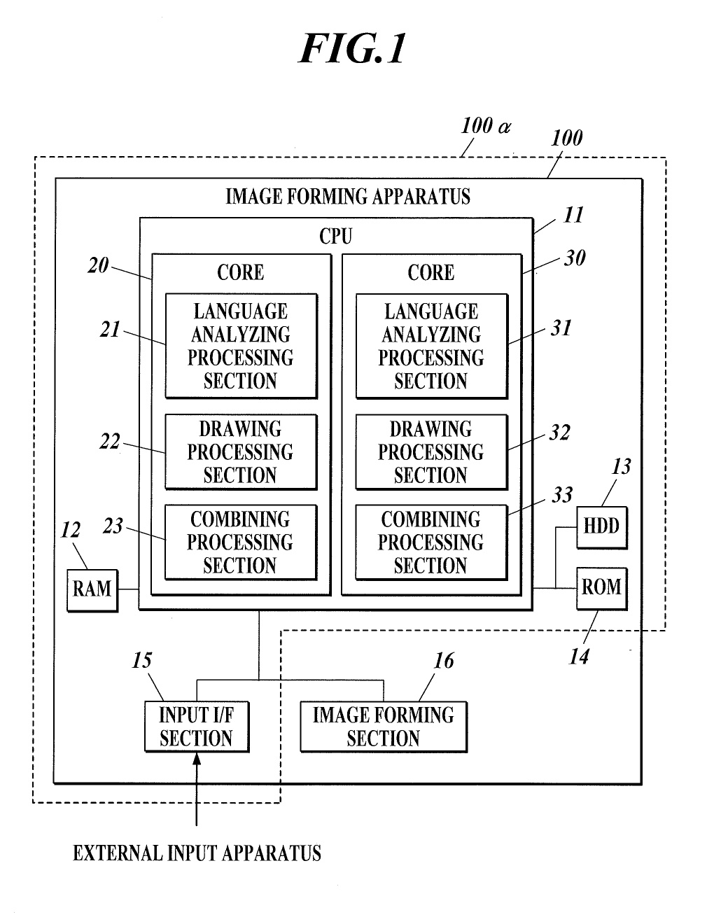

The first embodiment of the present invention is described with reference to FIG. 1 to FIG. 10. First, the configuration of the apparatus of the present embodiment is described with reference to FIG. 1. FIG. 1 is a diagram showing a functional configuration of the image forming apparatus 100 of the present embodiment.

The image forming apparatus 100 is an image forming apparatus compliant to PDL. The image forming apparatus 100 is an apparatus to form (print) an image on a sheet based on print data which is PDL data received from an external input apparatus such as a PC, etc. Here, the image forming apparatus 100 is a printer, however the present invention is not limited to this, and other image forming apparatuses can be applied such as a MFP (Multi-Function Peripheral), etc.

The image forming apparatus 100 includes a CPU 11 as a control section, a RAM 12, a HDD (Hard Disk Drive) 13, a ROM (Read Only Memory) 14, an input I/F section 15 and image forming section 16.

As shown in FIG. 1, the CPU 11, the RAM 12, the HDD 13, the ROM 14, the input I/F section 15 and an output I/F section (not shown) can be configured as an image processing apparatus 100α as a printer controller. The image processing apparatus 100α is connected to the image forming apparatus as an external device and transmits generated printable data with the output I/F section to the image forming apparatus and forms (prints) an image on a sheet.

The CPU 11 controls each section of the image forming apparatus 100. The CPU 11 is a dual core processor including cores 20, 30 as a computing section. The CPU 11 (cores 20, 30) reads out a program from the ROM 14 and expands the program in the RAM 12 as necessary, and in coordination with the program, performs various processing. Specifically, in coordination with a language analyzing processing program read out from the ROM 14, the core 20 functions as a language analyzing processing section 21. In coordination with a first drawing processing program read out from the ROM 14, the core 20 functions as a drawing processing section 22. In coordination with a first combining processing program read out from the ROM 14, the core 20 functions as a combining processing section 23. In coordination with a language analyzing processing program read out from the ROM 14, the core 30 functions as a language analyzing processing section 31. In coordination with a second drawing processing program read out from ROM 14, the core 30 functions as a drawing processing section 32. In coordination with a first combining processing program read out from the ROM 14, the core 30 functions as a combining processing section 33.

Also, in the core 20, the language analyzing processing section 21, the drawing processing section 22 and the combining processing section 23 operate in a time sequence, and only one operates at one time. In the core 30, the language analyzing processing section 31, the drawing processing section 32 and the combining processing section 33 operate in a time sequence, and only one operates at one time.

The RAM 12 is a volatile memory and includes a work area to temporarily store various programs and various data. The HDD 13 includes a digital storage medium and is a storage section which can read and write data such as image data, additional font data, etc. The ROM 14 is a read only memory and stores various data such as various programs, font data, etc. Specifically, the ROM 14 stores the language analyzing program, the first drawing processing program, the second drawing processing program and the first combining processing program.

The input I/F section 15 is a communication section which inputs (receives) various data from an external input apparatus such as a PC 50 through a communication network, etc. The image forming section 16 is an image forming section of an electro-photographic type, ink jet type, etc. which forms (prints) an image on a sheet according to an input image signal (printable data).

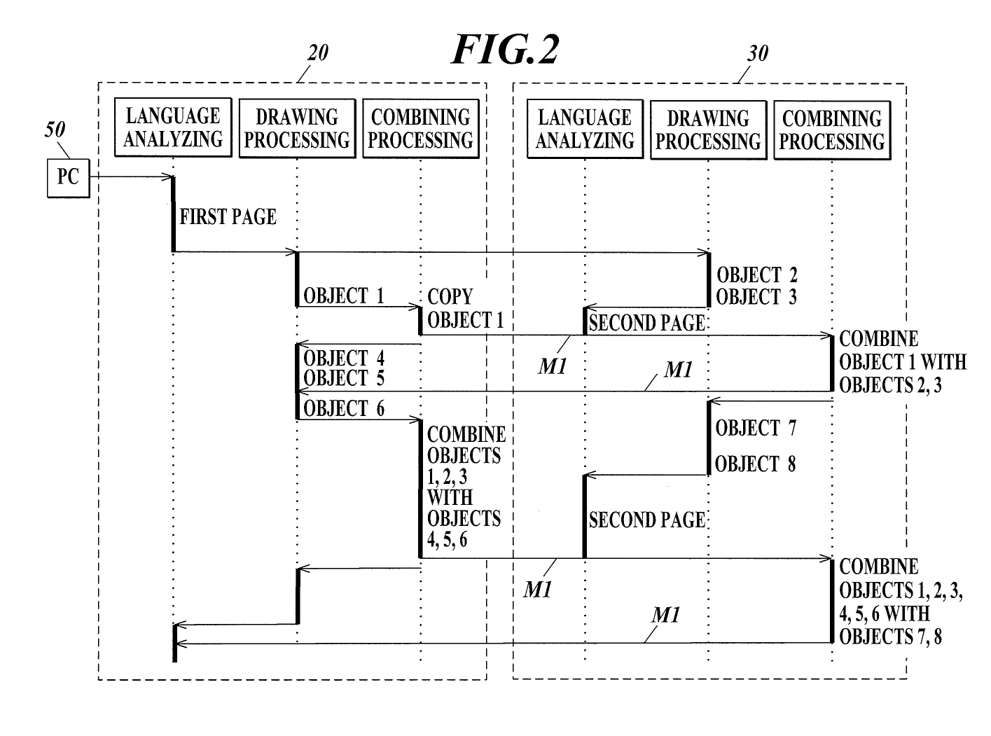

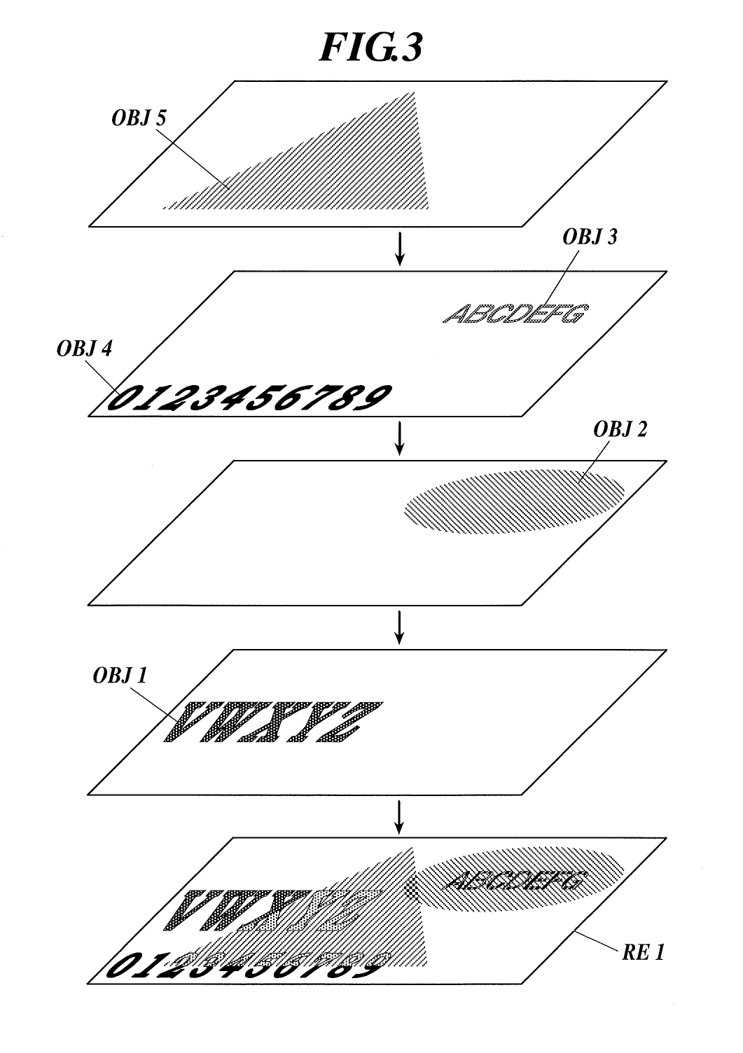

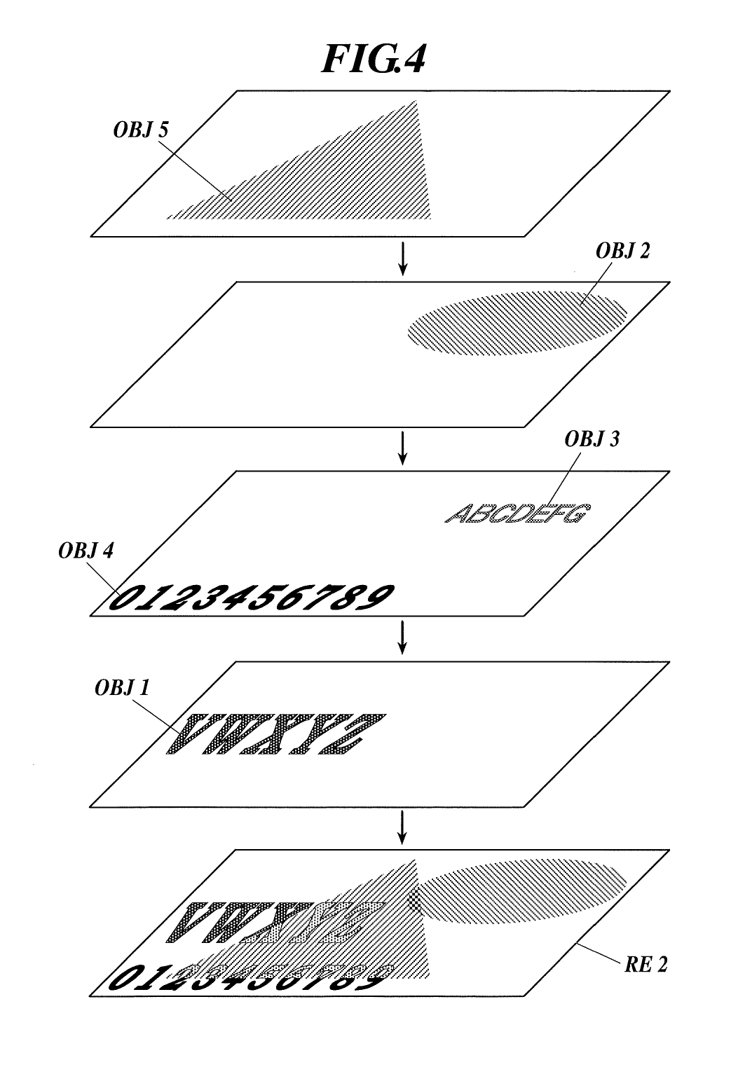

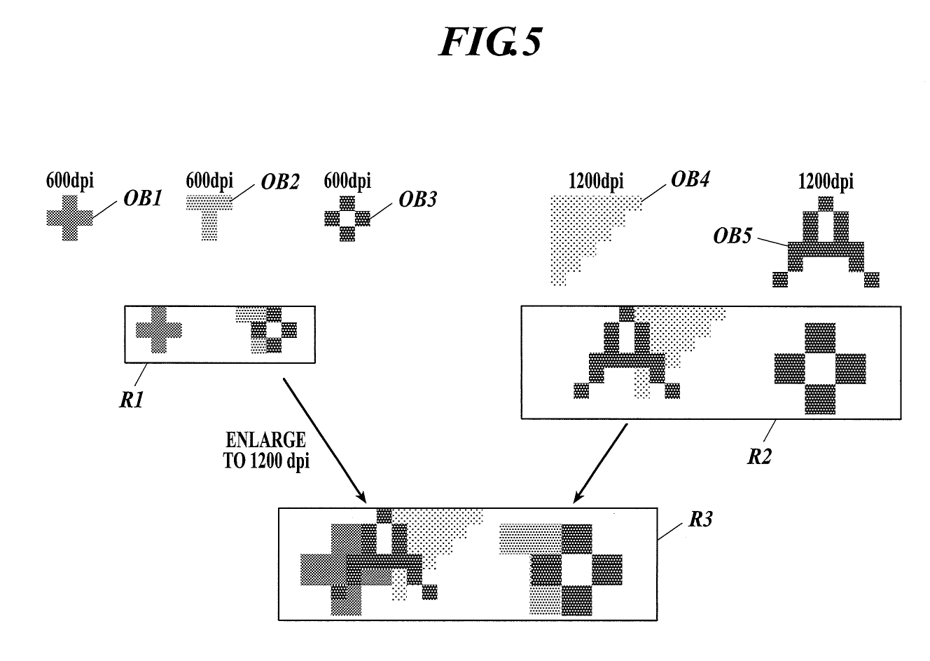

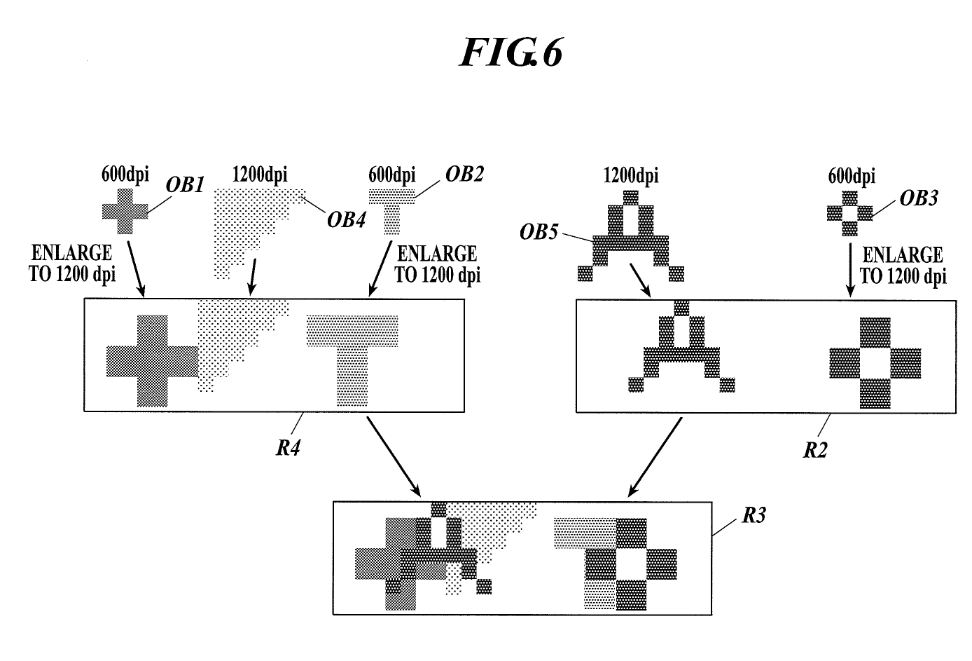

Next, the operation of image forming apparatus 100 is described with reference to FIG. 2 to FIG. 10. First, a summary of the operation of the image forming apparatus 100 is described with reference to FIG. 2 to FIG. 6. FIG. 2 is a ladder chart showing a language analyzing processing, drawing processing and combining processing performed in the core 20, 30 of the image forming apparatus 100. FIG. 3 is a diagram showing an example of combining processing performed in a preferable combining order. FIG. 4 is a diagram showing an example of combining processing performed in a wrong combining order. FIG. 5 is a diagram showing an example of combining processing using a band area in which a resolution of an object is different in each core. FIG. 6 is a diagram showing an example of combining processing using a band area in which a resolution of an object is mixed in each core.

First, a total flow of the image forming processing of the image forming apparatus 100 is described briefly. The CPU 11 of the image forming apparatus 100 receives print data from an external input apparatus. Then, with respect to each page, the CPU 11 (language analyzing processing section 21, 31) performs language analysis (page analysis) of the received print data and generates a DL and stores the DL in the RAM 12.

With respect to each band, the CPU 11 (drawing processing section 22, 32) reads out the DL from the RAM 12, rasterizes the (drawing) object included in the DL and stores the data of the rasterized object in the RAM 12. With respect to each band, the CPU 11 (combining processing section 23, 33) reads out the data of the rasterized object from the RAM 12, combines the data, and stores the data as printable data in the RAM 12. Then, when a page of printable data is stored in the RAM 12, the CPU 11 allows the image forming section 16 to print the page of printable data.

An example of an operation of the image forming apparatus 100 is described with reference to FIG. 2. As shown in FIG. 2, the image forming apparatus 100 forms an image of the print data (PDL data) input from the PC 50. The image of the print data is mixed with text/line objects and objects other than text/line objects. The text/line object is rasterized at a high resolution and the dpi is set to 1200 dpi. The object other than the text/line object is rasterized at a low resolution and the dpi is set to 600 dpi. Also, the object number on FIG. 2 shows a serial number indicating the order the objects are overlapped and the same applies for the other embodiments.

The core 20 is a core to perform rasterizing at a low resolution (600 dpi). The core 30 is a core to perform rasterizing at a high resolution (1200 dpi). The objects 1, 4, 5, 6 are objects other than text/line objects and the objects 2, 3, 7, 8 are text/line objects. The objects 1 to 8 are objects of the first band of the first page.

First, in the core 20, the language analyzing processing section 21 performs language analyzing processing on the first page of the print data and generates the DL. After the language analyzing processing of the first page is finished, the drawing processing section 22 rasterizes the object 1 from the generated DL at 600 dpi and expands the object 1 in the memory area of the band for the core 20 in the RAM 12. Also, the drawing processing section 32 rasterizes the objects 2, 3 from the generated DL in order at 1200 dpi, and expands the objects 2, 3 in the memory area of the band for the core 30 in the RAM 12.

After the object 1 is rasterized, the combining processing section 23 enlarges the data of the rasterized object 1 to 1200 dpi and combines (copies) the data in the combining area of the RAM 12. After combining the object 1, the combining processing section 23 notifies a message M1 of transfer of authority of combining processing to the core 30. Also, after the rasterizing of the objects 2, 3, the language analyzing processing section 31 performs language analyzing processing of the second page of the print data and generates the DL. After combining (copying) the object 1, in response to the message M1 of transfer of authority of combining processing, the combining processing section 33 combines the data of the rasterized objects 2, 3 to the data of the object 1 in the combining area in the RAM 12. After combining objects 1, 2, 3, the combining processing section 33 notifies the message M1 of transfer of authority of combining processing to the core 20.

Then, after combining (copying) the object 1, the drawing processing section 22 rasterizes the objects 4, 5, 6 from the generated DL in order at 600 dpi and expands the objects in the memory area of the band for the core 20 in the RAM 12. Also, after the combining of the objects 1, 2, 3, the drawing processing section 32 rasterizes the objects 7, 8 from the generated DL in order at 1200 dpi and expands the objects in the memory area of the band for the core 30 in the RAM 12.

Then, after rasterizing the objects 4, 5, 6, the combining processing section 23 enlarges the data of the rasterized objects 4, 5, 6 to 1200 dpi and the data is combined to the data of objects 1, 2, 3 of the combining area of the RAM 12. After combining the objects 1 to 6, the combining processing section 23 notifies the message M1 of transfer of authority of combining processing to the core 30. Also, after rasterizing the objects 7, 8, the language analyzing processing section 31 continues the rest of the language analyzing processing of the second page of the print data and generates the DL. After combining the objects 1 to 6, in response to the message M1 of transfer of authority of combining processing, the combining processing section 33 combines the data of the rasterized objects 7, 8 to the data of the objects 1 to 6 in the combining area in the RAM 12. After combining the objects 1 to 8, the combining processing section 33 notifies the message M1 of transfer of authority of combining processing to the core 20. In this way, the language analyzing processing, drawing processing and combining processing are performed in the cores 20, 30.

The drawing processing sections 22, 32 respectively overlap the rasterized data of the objects which have the same resolution and which are in a consecutive order of overlapping in order including transmission. Therefore, for example, as shown in FIG. 3, the data of object OBJ 1, the data of object OBJ 2, the data of objects OBJ 3, OBJ 4, and the data of object OBJ 5 are overlapped in order and combined and a preferable combined result RE 1 is achieved. As shown in FIG. 4, if the data of object OBJ 1, the data of objects OBJ 3, OBJ 4, the data of object OBJ 2, and the data of object OBJ 5 are overlapped in this order and combined, this results in combined result RE 2 and a preferred combined result cannot be achieved.

Also, the core 20 processes the object of 600 dpi and the core 30 processes the object of 1200 dpi. In this configuration, in the core 20, after the drawing processing section 22 rasterizes the object at 600 dpi, the combining processing section 23 enlarges the data of the rasterized object to 1200 dpi and combines the data. For example, as shown in FIG. 5, objects OB 1, OB 2, OB 3, OB 4 and OB 5 which are in the same band area are considered. The drawing processing section 22 rasterizes the objects OB 1, OB 2 and OB 3 at 600 dpi and stores the raserized data in area R1 for the core 20 in the RAM 12. Also, the drawing processing section 32 rasterizes the objects OB 4, OB 5 at 1200 dpi and stores the rasterized data in area R2 for the core 30 in the RAM 12.

When the data is combined, the combining processing section 23 enlarges the data of the area R1 to 1200 dpi and stores the data in the combining area R3 of the RAM 12. Also, the combining processing section 33 stores the data of the area R2 as is in the combining area R3 of the RAM 12. In this way, the enlarging processing to 1200 dpi is performed only in the combining processing of core 20 and the area R1 can be a volume for 600 dpi smaller than a volume for 1200 dpi.

The following assumes a configuration where each of the cores 20, 30 respectively process objects of both 600 dpi and 1200 dpi. Then, for example, as shown in FIG. 6, the drawing processing section 22 rasterizes objects OB 1, OB 2 at 600 dpi and then enlarges the objects to 1200 dpi, and rasterizes the object OB 4 at 1200 dpi, and the above data is stored in the area R4 for the core 20 in the RAM 12. Also, the drawing processing section 32 rasterizes the object OB 3 at 600 dpi and enlarges the object to 1200 dpi and stores the data in the area R2 for the core 30 of the RAM 12.

When combined, the combining processing section 23 combines the data of area R4 as is in the combining area R3 of the RAM 12. Also, combining processing section 33 stores the data of area R2 as is in the combining area R3 of the RAM 12. In this way, the enlarging processing to 1200 dpi is performed in the drawing processing of the cores 20, 30. As a result, there are objects with various resolutions and there is a necessity to provide a band area of the maximum resolution with respect to each core. Moreover, since the volume of the area R4 is larger than the volume of the area R1, the necessary memory of the RAM 12 increases. Further, enlarging processing is performed each time in the cores 20, 30.

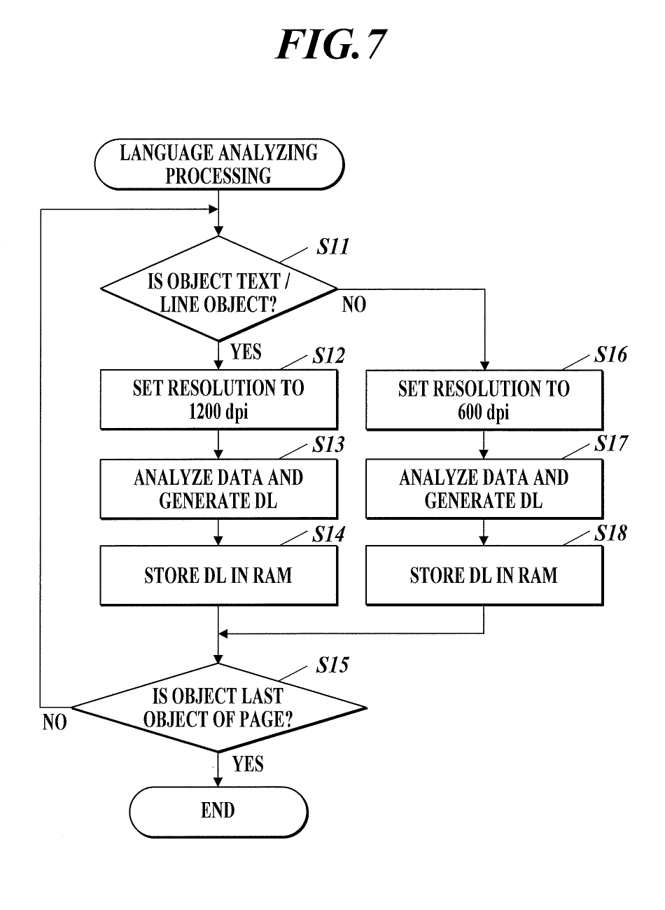

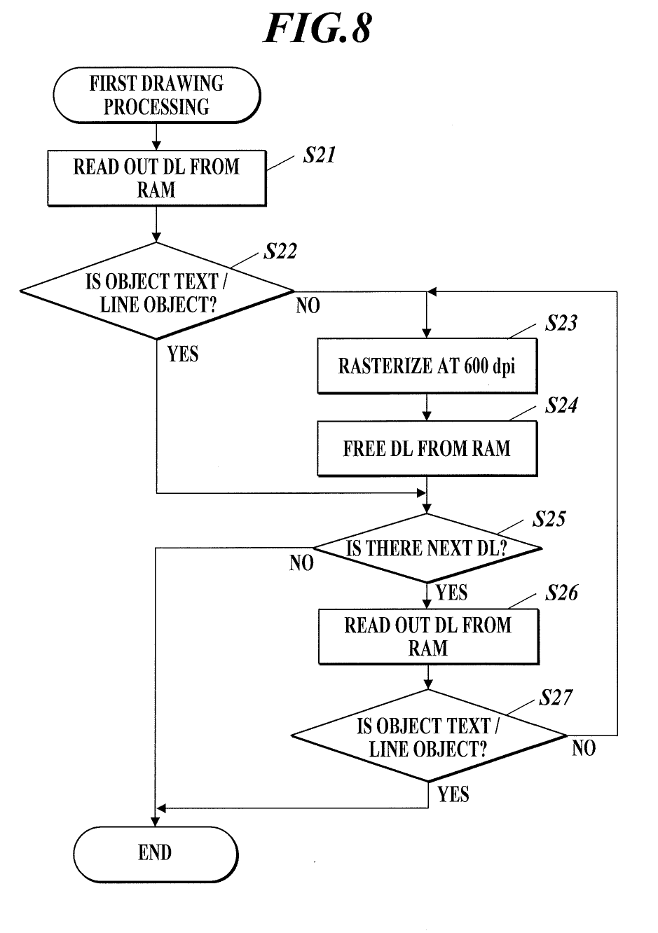

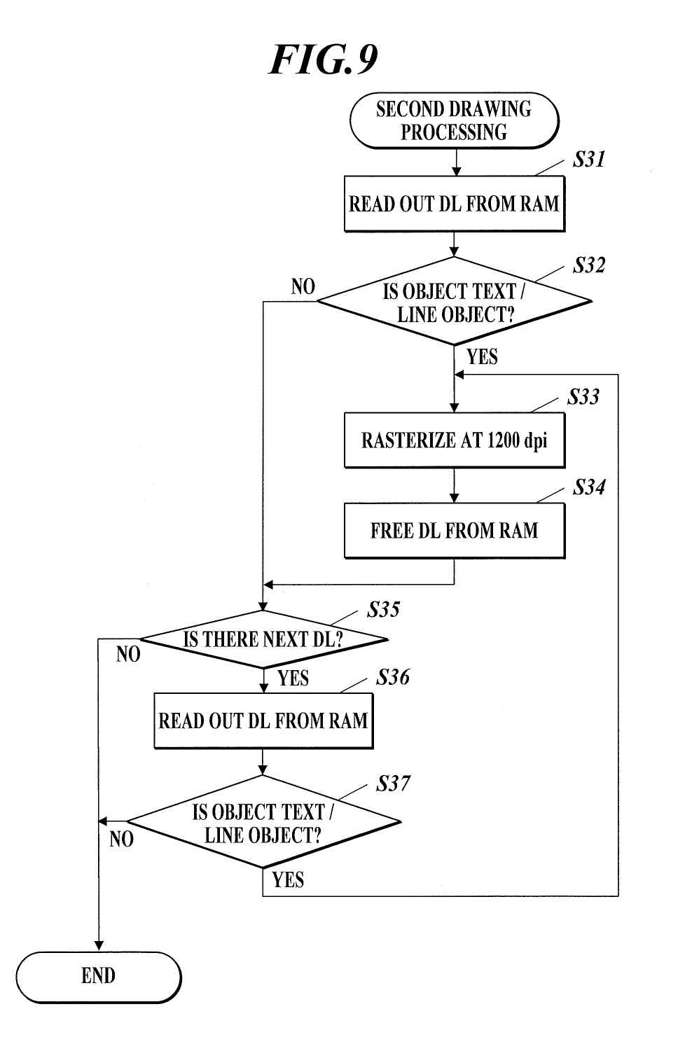

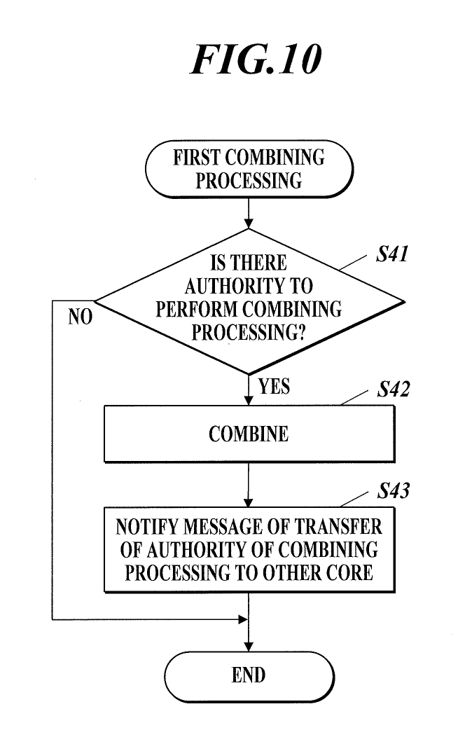

Next, the operation of the cores 20, 30 is described in detail with reference to FIG. 7 to FIG. 10. FIG. 7 is a flowchart showing a language analyzing processing. FIG. 8 is a flowchart showing a first drawing processing. FIG. 9 is a flowchart showing a second drawing processing. FIG. 10 is a flowchart showing a first combining processing.

The language analyzing processing performed in the language analyzing processing sections 21, 31 is described with reference to FIG. 7. In the example described here, the language analyzing processing section 21 performs the processing, and the same applies for the language analyzing processing section 31. For example, when print data (PDL data) of at least one page is input in the input I/F section 15, and there is no authority to perform combining processing in the core and rasterizing is not performed, this acts as a trigger and the core 20 functions with the language analyzing processing program so that the language analyzing processing section 21 performs language analyzing processing.

First, the language analyzing processing section 21 extracts an object not yet extracted from the page of the print data with an order of overlapping when combined being early, and judges whether or not the extracted object is a text/line object or not (step S11). When the object is a text/line object (step S11; YES), the language analyzing processing section 21 sets the resolution of the object extracted in step S11 to 1200 dpi (high resolution) (step S12). Then, the language analyzing processing section 21 performs data analysis of the object extracted in step S11 and generates the DL (step S13). Then, the language analyzing processing section 21 stores the DL generated in step S13 in the RAM 12 (step S14).

Then, the language analyzing processing section 21 judges whether or not the object extracted in step S11 is the last object of the page (step S15). When the object is not the last object of the page (step S15; NO), the processing advances to step S11. When the object is the last object of the page (step S15; YES), the language analyzing processing ends.

When the object is not a text/line object (step S11; NO), the language analyzing processing section 21 sets the resolution of the object extracted in step S11 to 600 dpi (low resolution) (step S16). Then, the language analyzing processing section 21 performs data analysis of the object extracted in step S11 and generates the DL (step S17). Then, the language analyzing processing section 21 stores the DL generated in step S17 in the RAM 12 (step S18) and the processing advances to step S15.

Next, the first drawing processing performed in the drawing processing section 22 is described with reference to FIG. 8. For example, the language analyzing processing ending or the first combining processing in the core 20 ending acts as a trigger, and the core 20 functions with the first drawing processing program so that the drawing processing section 22 performs the first drawing processing.

First, the drawing processing section 22 reads out the DL from the RAM 12 (step S21). Then, the drawing processing section 22 judges whether or not the object of the DL read out in step S21 is a text/line object (step S22). When the object is not a text/line object (step S22; NO), the drawing processing section 22 rasterizes the DL read out in step S21 or S26 at 600 dpi and stores the DL in the memory area of the band for core 20 in the RAM 12 (step S23). Then, the drawing processing section 22 frees the DL from the RAM 12 (step S24).

Then, the drawing processing section 22 refers to the RAM 12 and judges whether or not there is a next DL (step S25). When the object is a text/line object (step S22; YES), the processing advances to step S25. When there is a next DL (step S25; YES), the drawing processing section 22 reads out the next DL from the RAM 12 (step S26). Then, the drawing processing section 22 judges whether or not the object of the DL read out from the step S26 is a text/line object (step S27).

When the object is not a text/line object (step S27; NO), the processing advances to step S23. When there are no more DL (step S25; NO), or the object is a text/line object (step S27; YES), the first drawing processing ends.

Next, the second drawing processing performed in the drawing processing section 32 is described with reference to FIG. 9. For example, the language analyzing processing ending or the first combining processing in the core 30 ending acts as a trigger, and the core 30 functions with the second drawing processing program so that the drawing processing section 32 performs the second drawing processing.

First, the drawing processing section 32 reads out the DL from the RAM 12 (step S31). Then, the drawing processing section 32 judges whether or not the object of the DL read out in step S31 is a text/line object (step S32). When the object is a text/line object (step S32; YES), the drawing processing section 32 rasterizes the DL read out in step S31 or S36 at 1200 dpi and stores the DL in the memory area of the band for core 30 in RAM 12 (step S33). Then, the drawing processing section 32 frees the DL from the RAM 12 (step S34).

Then, the drawing processing section 22 refers to the RAM 12 and judges whether or not there is a next DL (step S35). When the object is not a text/line object (step S32; NO), the processing advances to step S35. When there is a next DL (step S35; YES), the drawing processing section 32 reads out the next DL from the RAM 12 (step S36). Then, the drawing processing section 32 judges whether or not the object of the DL read out in step S36 is a text/line object or not (step S37).

When the object is a text/line object (step S37; YES), the processing advances to step S33. When there are no more DL (step S35; NO), or the object is not a text/line object (step S37; NO), the second drawing processing ends.

Next, the first combining processing performed in the combining processing sections 23, 33 is described with reference to FIG. 10. In the example described here, the combining processing section 23 performs the processing, however the same can be said for the combining processing section 33. The first combining processing is performed repeatedly in a predetermined cycle. For example, a predetermined cycle passing functions as a trigger, and the core 20 and the first combining processing program function together so that the combining processing section 23 performs the first combining processing.

First, the combining processing section 23 judges whether or not there is authority of combining processing (step S41). When there is authority of combining processing (step S41; YES), the combining processing section 23 reads out data of the memory area of the band of its own core (core 20) in the RAM 12 and combines the data to the data of the combining area of the RAM 12 (step S42). In step S42, the combining processing section 23 reads out the data of the memory area of the band of the core 20 in RAM 12 and enlarges the data by two times vertically and horizontally (to 1200 (dpi)), and combines the data to the data of the combining area of the RAM 12. In step S42, the combining processing section 33 does not perform the enlarging processing. Then, the combining processing section 23 notifies the transfer of the authority of combining processing to the other core (core 30) (step S43) and the first combining processing ends. When there is no combining processing authority (step S41; NO), the first combining processing ends.

According to the above described embodiment, the image forming apparatus 100 includes a CPU 11 including cores 20, 30 which each perform language analyzing processing, drawing processing and combining processing to generate printable data based on PDL data (print data) and an image forming section 16. The language analyzing processing performs language analysis of the PDL data and generates the DL of the object. The drawing processing performs rasterizing of the object of the DL. The combining processing combines the data of the rasterized object. Each of the cores 20, 30 are set to either one of the two types of resolutions for rasterizing. Specifically, the resolution of the core 20 is set to 600 dpi. The resolution of the core 30 is set to 1200 dpi. The rasterizing of the drawing processing in the cores 20, 30 are performed in parallel in each core 20, 30 at the resolution set in each core 20, 30. In the combining processing of the core 20, the data of the object after rasterizing with the low resolution (600 dpi) is enlarged to the highest resolution (1200 dpi) and combined.

Therefore, the image processing of the PDL data can be performed at a high speed and high definition image forming can be realized. Also, the storage area of the RAM 12 used in the combining processing of the core 20 can be made small.

Also, the first drawing processing rasterizes the text/line object at a high resolution (1200 dpi). The second drawing processing rasterizes the object other than the text/line object at a low resolution (600 dpi). Therefore, the edge, etc. of the text/line object can be smoothed and high definition image forming can be realized.

Moreover, in the first combining processing, the group of data of the object rasterized at a low resolution (600 dpi) and the group of data of the object rasterized at a high resolution (1200 dpi) are combined alternately in the overlapping order. Therefore, image forming can be performed with the proper order of overlapping.

### Second Embodiment

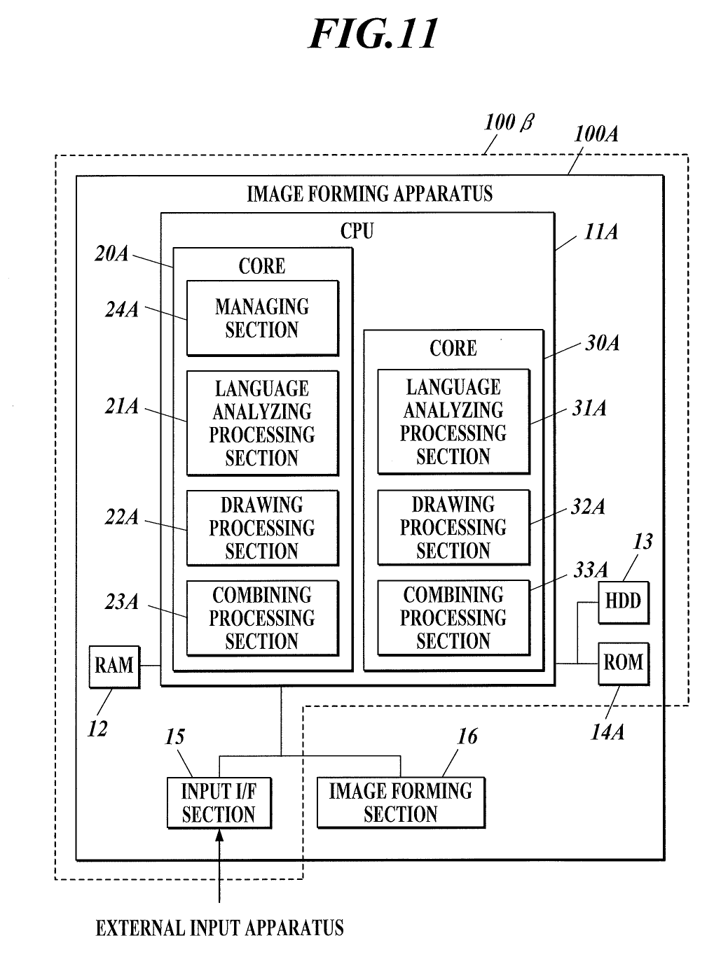

The second embodiment of the present invention is described with reference to FIG. 11 to FIG. 16. First, the configuration of the apparatus of the present embodiment is described with reference to FIG. 11. FIG. 11 is a diagram showing a functional configuration of the image forming apparatus 100A of the present embodiment.

The image forming apparatus 100A is an image forming apparatus compliant to PDL. The image forming apparatus 100A is an apparatus to form (print) an image on a sheet based on print data which is PDL data received from an external input apparatus such as a PC, etc. Here, the image forming apparatus 100A is a printer, however the present invention is not limited to this, and other image forming apparatuses can be applied such as a MFP (Multi-Function Peripheral), etc. Moreover, in the image forming apparatus 100A, the same reference numerals are applied to the sections which are the same as the image forming apparatus 100 of the first embodiment, and the description is omitted.

The image forming apparatus 100A includes a CPU 11A as a control section, a RAM 12, a HDD 13, a ROM 14A, an input I/F section 15 and image forming section 16.

As shown in FIG. 11, the CPU 11A, the RAM 12, the HDD 13, the ROM 14A, the input I/F section 15 and an output I/F section (not shown) can be configured as an image processing apparatus 100β as a printer controller. The image processing apparatus 100β is connected to the image forming apparatus as an external device and transmits generated printable data with the output I/F section to the image forming apparatus and forms (prints) an image on a sheet.

The CPU 11A controls each section of the image forming apparatus 100A. The CPU 11A is a dual core processor including cores 20A, 30A as a computing section. The CPU 11A (cores 20A, 30A) reads out a program from the ROM 14A and expands the program in the RAM 12 as necessary, and in coordination with the program, performs various processing. Specifically, in coordination with a language analyzing processing program read out from the ROM 14A, the core 20A functions as a language analyzing processing section 21A. In coordination with a third drawing processing program read out from the ROM 14A, the core 20A functions as a drawing processing section 22A. In coordination with a second combining processing program read out from the ROM 14A, the core 20A functions as a combining processing section 23A. In coordination with a managing program read out from the ROM 14A, the core 20A functions as a managing section 24A.

Moreover, in coordination with a language analyzing processing program read out from the ROM 14A, the core 30A functions as a language analyzing processing section 31A. In coordination with a fourth drawing processing program read out from the ROM 14A, the core 30A functions as a drawing processing section 32A. In coordination with a second combining processing program read out from the ROM 14A, the core 30A functions as a combining processing section 33A.

Also, in the core 20A, the language analyzing processing section 21A, the drawing processing section 22A and the combining processing section 23A operate in a time sequence, and only one operates at one time. Moreover, in the core 20A, the language analyzing processing section 21A, the drawing processing section 22A or the combining processing section 23A operate simultaneously with the managing section 24A in a time sequence. In the core 30A, the language analyzing processing section 31A, the drawing processing section 32A and the combining processing section 33A operate in a time sequence, and only one operates at one time.

The ROM 14A is a read only memory and stores various data such as various programs, font data, etc. Specifically, the ROM 14A stores the language analyzing program, the third drawing processing program, the fourth drawing processing program, the second combining processing program and the managing program.

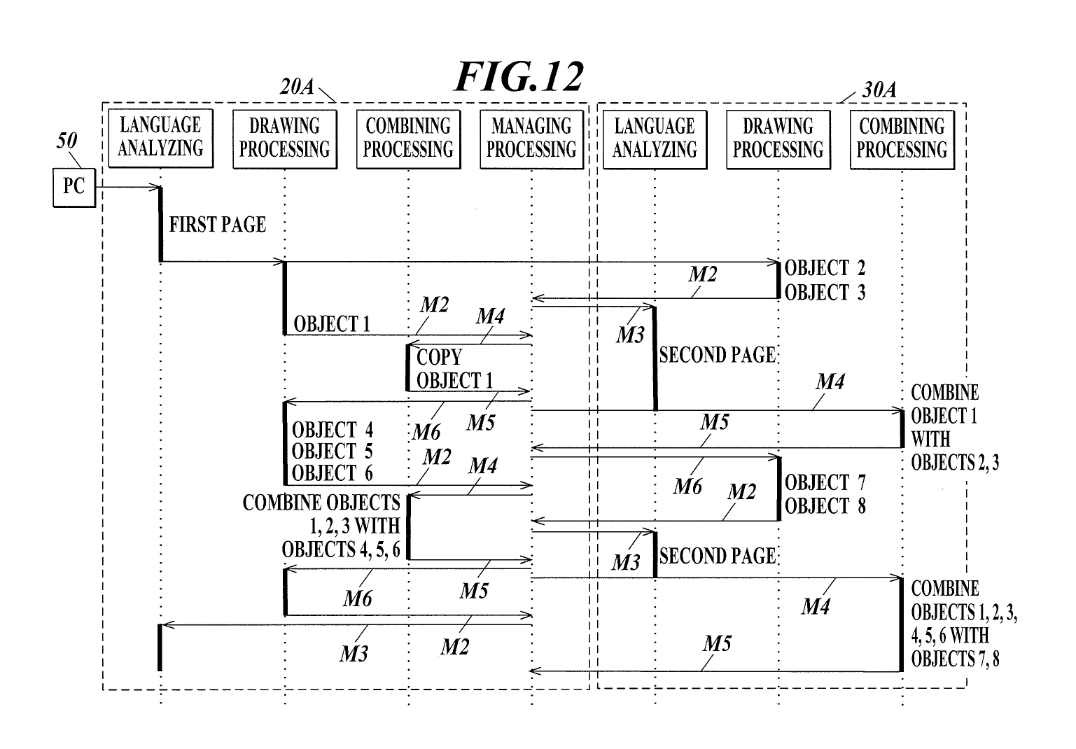

Next, the operation of image forming apparatus 100A is described with reference to FIG. 12 to FIG. 16. First, a summary of the operation of the image forming apparatus 100A is described with reference to FIG. 12. FIG. 12 is a ladder chart showing a language analyzing processing, drawing processing and combining processing performed in the cores 20A, 30A of the image forming apparatus 100A.

The total flow of the image forming processing of the image forming apparatus 100A is similar to that of the image forming apparatus 100. An example of the operation of the image forming apparatus 100A is described with reference to FIG. 12. As shown in FIG. 12, the image forming apparatus 100A forms an image of the print data input from the PC 50. The image of the print data is mixed with text/line objects (rasterized at a high resolution (1200 dpi)) and objects other than text/line objects (rasterized at a low resolution (600 dpi)).

Also, the core 20A is a core to perform rasterizing at a low resolution (600 dpi). The core 30A is a core to perform rasterizing at a high resolution (1200 dpi). The objects 1, 4, 5, 6 are objects other than text/line objects and the objects 2, 3, 7, 8 are text/line objects. The objects 1 to 8 are objects of the first band of the first page.

First, in the core 20A, the language analyzing processing section 21A performs language analyzing processing on the first page of the print data and generates the DL. After the language analyzing processing of the first page is finished, the drawing processing section 22A rasterizes the object 1 from the generated DL at 600 dpi and expands the object 1 in the memory area of the band for the core 20A in the RAM 12. Also, the drawing processing section 32A rasterizes the objects 2, 3 from the generated DL in order at 1200 dpi, and expands the objects 2, 3 in the memory area of the band for the core 30A in the RAM 12. After the rasterizing of the objects 2, 3, the drawing processing section 32A notifies a message M2 of completion of preparation of combining to the managing section 24A.

Then, in response to the message M2 of completion of preparation of combining from the drawing processing section 32A, the managing section 24A notifies a message M3 of standby of combining to the language analyzing processing section 21A. In response to the message M3 of standby of combining, the language analyzing processing section 31A performs the language analyzing processing of the second page of the print data and generates the DL. Then, after rasterizing the object 1, the drawing processing section 22A notifies the message M2 of completion of preparation of combining to the managing section 24A. Then, in response to the message M2 of completion of preparation of combining from the drawing processing section 22A, the managing section 24A notifies message M4 of start of the combining processing to the combining processing section 23A. In response to the message M4 of start of the combining processing, the combining processing section 23A enlarges the data of the rasterized object 1 to 1200 dpi and combines (copies) the data in the combining area of the RAM 12. After combining the object 1, the combining processing section 23A notifies a message M5 of request of notification of completion of combining processing to the managing section 24A.

Then, in response to the message M5 of request of notification of completion of combining processing, the managing section 24A notifies a message M6 of completion of combining processing to the drawing processing section 22A. In response to the message M6 of completion of combining processing, the drawing processing section 22A rasterizes the objects 4, 5, 6 from the generated DL in order at 600 dpi and expands the objects in the memory area of the band for the core 20A in the RAM 12. Also, in response to the message M5 of request of notification of completion of combining processing, the managing section 24A notifies the message M4 of start of combining processing to the combining processing section 33A. In response to the message M4 of start of combining processing, the combining processing section 33A combines the data of the rasterized objects 2, 3 to the data of the object 1 in the combining area of the RAM 12. After combining the objects 1 to 3, the combining processing section 33A notifies the message M5 of request of notification of completion of combining processing to the managing section 24A.

Then, in response to the message M5 of request of notification of completion of combining processing, the managing section 24A notifies the message M6 of completion of combining processing to the drawing processing section 32A. In response to the message M6 of completion of combining processing, the drawing processing section 32A rasterizes the objects 7, 8 from the generated DL in order at 1200 dpi and expands the objects in the memory area of the band for the core 30 in the RAM 12.

Then, after rasterizing the objects 4, 5, 6, the drawing processing section 22A notifies the message M2 of completion of preparation of combining to the managing section 24A. In response to the message M2 of completion of preparation of combining, the managing section 24A notifies the message M4 of start of combining processing to the combining processing section 23A. In response to the message M4 of start of combining processing, the combining processing section 23A enlarges the data of the rasterized objects 4, 5, 6 to 1200 dpi and the data is combined to the data of objects 1, 2, 3 of the combining area of the RAM 12.

Then, after rasterizing the objects 7, 8, the drawing processing section 32A notifies the message M2 of completion of preparation of combining to the managing section 24A. In response to the message M2 of completion of preparation of combining, the managing section 24A notifies the message M3 of standby of combining to the language analyzing processing section 31A. In response to the message M3 of standby of combining, the language analyzing processing section 31A continues the language analyzing processing of the second page of the print data and generates the DL.

Then, after combining the objects 1 to 6, the combining processing section 33A notifies the message M5 of request of notification of completion of combining processing to the managing section 24A. In response to the message M5 of request of notification of completion of combining processing, the managing section 24A notifies the message M6 of completion of combining processing to the drawing processing section 32A. Also, in response to the message M5 of request of notification of completion of combining processing, the managing section 24A notifies the message M4 of start of combining processing to the combining processing section 33A. In response to the message M4 of the start of the combining processing, the combining processing section 33A combines the data of the rasterized objects 7, 8 to the data of the objects 1 to 6 in the combining area in the RAM 12. After combining the objects 1 to 8, the combining processing section 33A notifies the message M5 of request of notification of completion of combining processing to the managing section 24A. In this way, the language analyzing processing, drawing processing and combining processing are performed in the cores 20A, 30A.

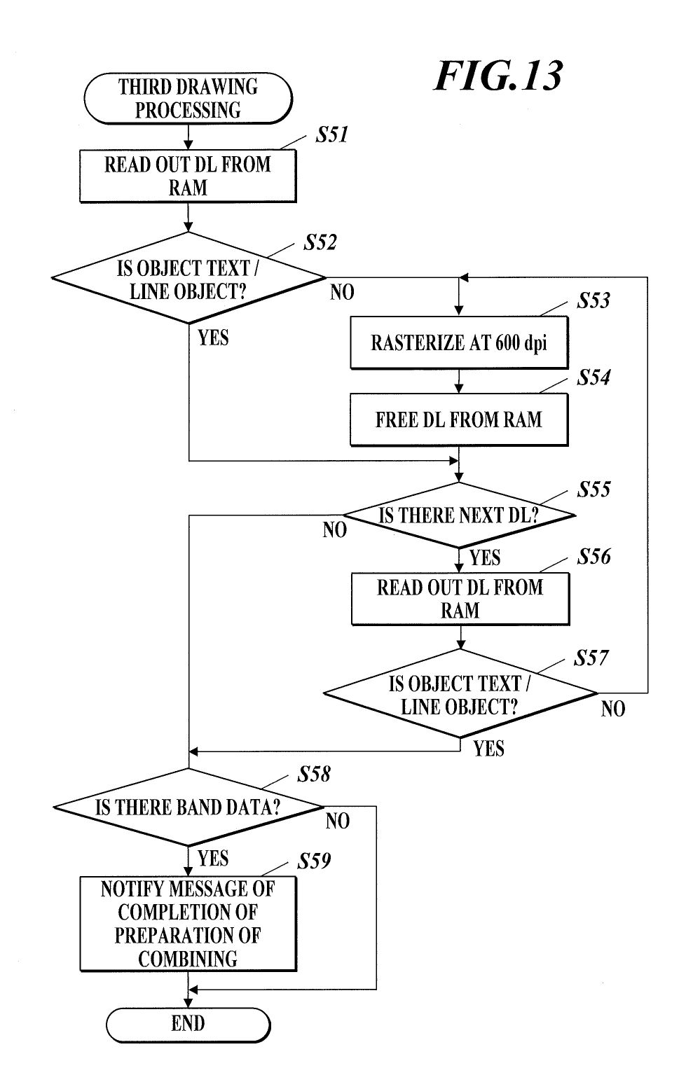

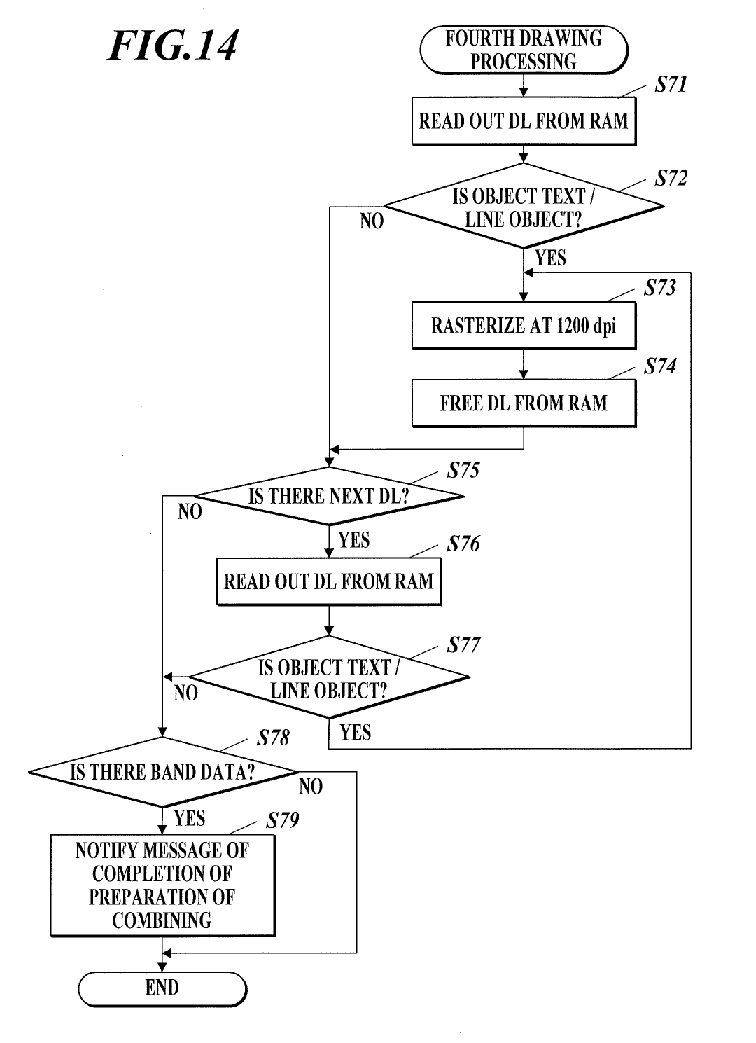

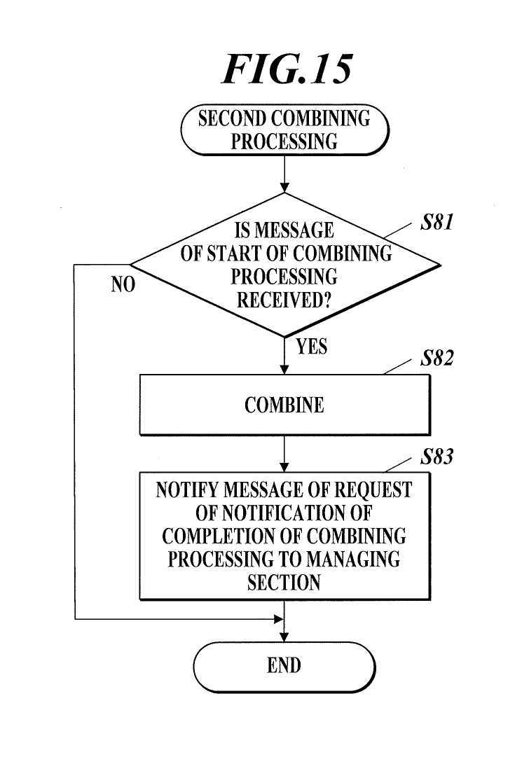

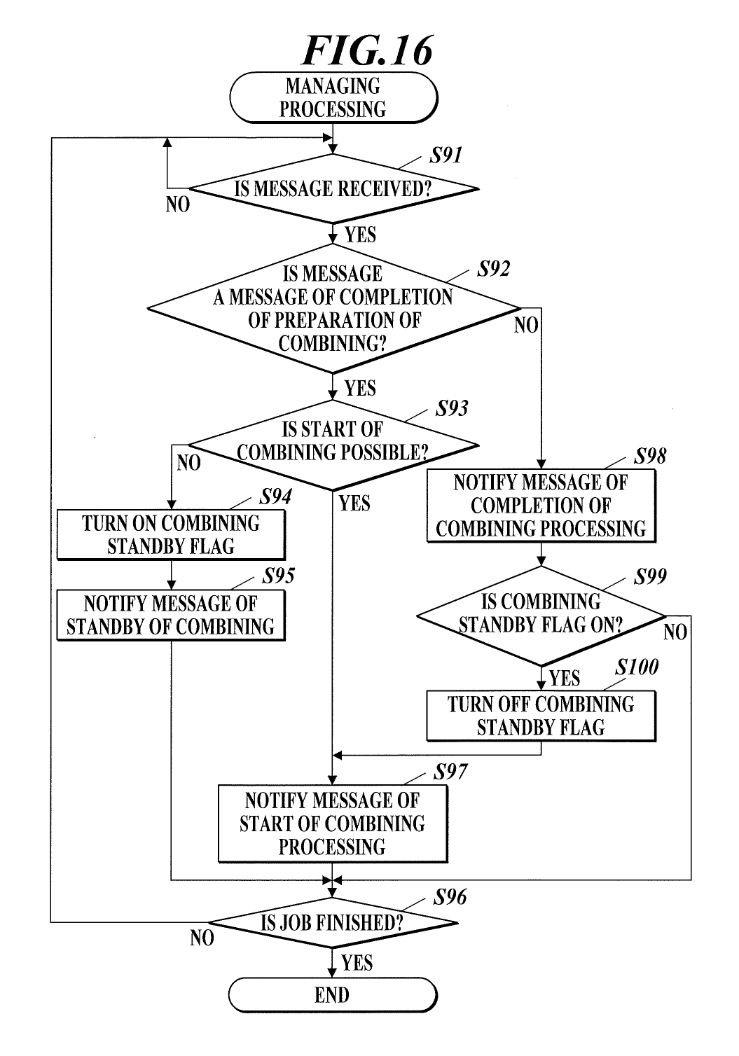

Next, the operation of the cores 20A, 30A is described in detail with reference to FIG. 13 to FIG. 16. FIG. 13 is a flowchart showing a third drawing processing. FIG. 14 is a flowchart showing a fourth drawing processing. FIG. 15 is a flowchart showing a second combining processing. FIG. 16 is a flowchart showing a managing processing.

The language analyzing processing performed in the language analyzing processing sections 21A, 31A are similar to that described in the first embodiment. The language analyzing processing performed in the language analyzing processing sections 21A, 31A is performed when print data of at least one page is input in the input I/F section 15, or the message M3 of standby of combining is received from the managing section 24A as a trigger.

The third drawing processing performed in the drawing processing section 22A is described with reference to FIG. 13. For example, the language analyzing processing in the core 20 ending or receiving the message M6 of completion of combining processing from the managing section 24A acts as a trigger, and the core 20A functions with the third drawing processing program so that the drawing processing section 22A performs the third drawing processing.

Steps S51 to S57 are similar to steps S21 to S27 of the first drawing processing. When there are no more DL (step S55; NO), or the object is a text/line object (step S57; YES), the drawing processing section 22A judges whether or not there is data in the memory area of the band for the core 20A in the RAM 12 (step S58). When there is no data in the memory area of the band for the core 20A (step S58; NO), the third drawing processing ends.

When there is data in the memory area of the band for the core 20A (step S58; YES), the drawing processing section 22A notifies the message M2 of completion of preparation of combining to the managing section 24A (step S59) and the third drawing processing ends.

The fourth drawing processing performed in the drawing processing section 32A is described with reference to FIG. 14. For example, the language analyzing processing ending or receiving the message M6 of the completion of combining processing from the managing section 24A acts as a trigger, and the core 30A functions with the fourth drawing processing program so that the drawing processing section 32A performs the fourth drawing processing.

Steps S71 to S77 are similar to steps S31 to S37 of the second drawing processing. When there are no more DL (step S75; NO), or the object is not a text/line object (step S77; NO), the drawing processing section 32A judges whether or not there is data in the memory area of the band for the core 30A of the RAM 12 (step S78). When there is no data in the memory area of the band for the core 30A (step S78; NO), the fourth drawing processing ends.

When there is data in the memory area of the band for the core 30A (step S78; YES), the drawing processing section 32A notifies the message M2 of completion of preparation of combining to the managing section 24A (step S79), and the fourth drawing processing ends.

Next, the second combining processing performed in the combining processing sections 23A, 33A is described with reference to FIG. 15. In the example described here, the combining processing section 23A performs the processing, however the same can be said for the combining processing section 33A. The second combining processing is performed repeatedly in a predetermined cycle. For example, a predetermined cycle passing functions as a trigger, and the core 20A and the second combining processing program function together so that the combining processing section 23A performs the second combining processing.

First, the combining processing section 23A judges whether or not the message M4 of start of combining processing is received from the managing section 24A (step S81). When the message M4 of start of combining processing is received (step S81; YES), the combining processing section 23A reads out data of the memory area of the band of its own core (core 20) in the RAM 12 and combines the data to the data of the combining area of the RAM 12 (step S82). In step S82, the combining processing section 23A reads out the data of the memory area of the band of the core 20 in the RAM 12 and enlarges the data by two times vertically and horizontally (to 1200 (dpi)), and combines the data to the data of the combining area of the RAM 12. In step S82, the combining processing section 33A does not perform the enlarging processing. Then, the combining processing section 23A notifies the message M5 of request of notification of completion of combining processing to the managing section 24A (step S83) and the second combining processing ends. When the message M4 of start of combining processing is not received (step S81; NO), the second combining processing ends.

Next, the managing processing performed by the managing section 24A is described with reference to FIG. 16. For example, a job input in the image forming apparatus 100A acts as a trigger and the core 20A functions with the managing program so that the managing section 24A performs the managing processing.

First, the managing section 24A judges whether or not a message is received from the drawing processing sections 22A, 32A, or the combining processing sections 23A, 33A (step S91). When a message is not received (step S91; NO), the processing advances to step S91. When a message is received (step S91; YES), the managing section 24A judges whether or not the message received in step S91 is a message M2 of completion of preparation of combining from the drawing processing sections 22A, 32A (step S92). When the message is the message M2 of completion of preparation of combining (step S92; YES), the managing section 24A judges whether or not the order of the object in which the preparation of combining is complete corresponding to the received message M2 of completion of preparation of combining is next in order of the overlapping (whether or not it is possible to start combining) (step S93).

When it is not possible to start combining (step S93; NO), the managing section 24A turns the combining standby flag to on (step S94). Then, the managing section 24A notifies the message M3 of standby of combining to the language analyzing processing section of the core of the drawing processing section of the sender of the message M2 of completion of preparation of combining (step S95). Then, the managing section 24A judges whether or not the input job is finished or not (step S96). When the job is not finished (step S96; NO), the processing advances to step S91. When the job is finished (step S96; YES), the managing processing ends.

When it is possible to start combining (step S93; YES), the managing section 24A notifies the message M4 of start of combining processing to the combining processing section of the core of the drawing processing section of the sender of message M2 of completion of preparation of combining (step S97) and the processing advances to step S96.

When the message is not the message M2 of completion of preparation of combining (step S92; NO), the message received in step S91 is the message M5 of request of notification of completion of combining processing, and the managing section 24A notifies the message M6 of completion of combining processing to the combining section of the core of the sender of the message M5 of request of notification of completion of combining processing (step S98). Then, the managing section 24A judges whether or not the combining standby flag is on (step S99). When the combining standby flag is not on (step S99; NO), the processing advances to step S96. When the combining standby flag is on (step S99; YES), the managing section 24A turns the combining standby flag to off (step S100) and the processing advances to step S97. In a case where the processing passes step S100, in step S97, the managing section 24A notifies the message M4 of start of combining processing to the combining processing section of the core different from the core of the drawing processing section of the sender of the message M2 of completion of combining processing.

As described above, according to the present embodiment, the same outstanding effects as the first embodiment can be achieved. Moreover, in the CPU 11A, the core 20A performs the managing processing to manage the performing of the language analyzing processing, the third and fourth drawing processing, and the second combining processing. Therefore, the performing of the language analyzing processing, the third and fourth drawing processing and the second combining processing can be managed appropriately.

### Third Embodiment

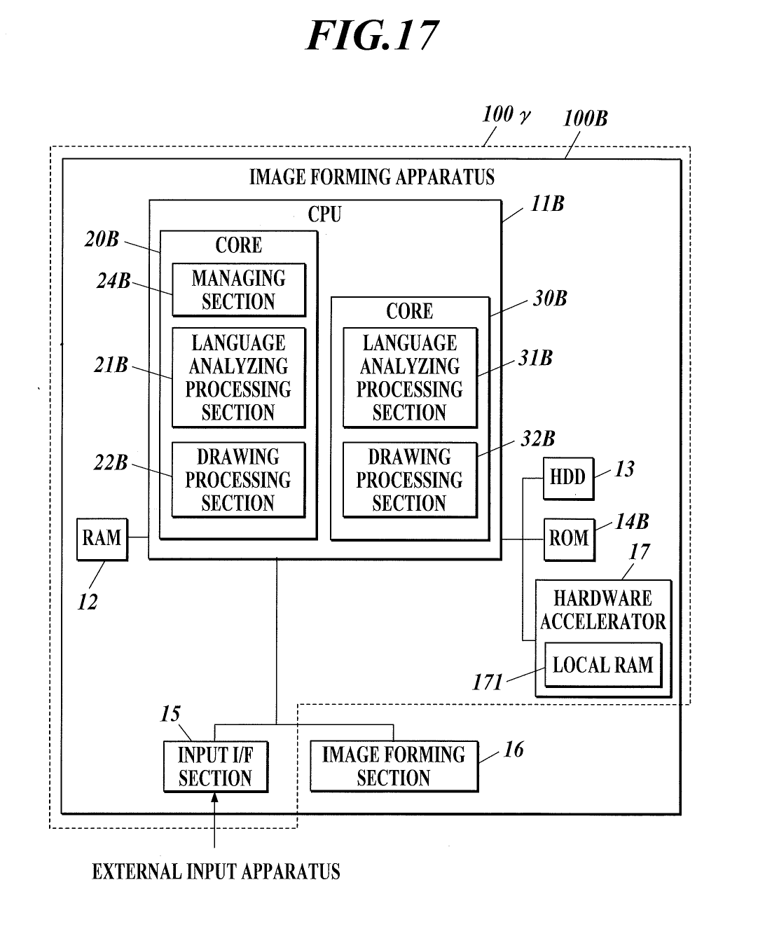

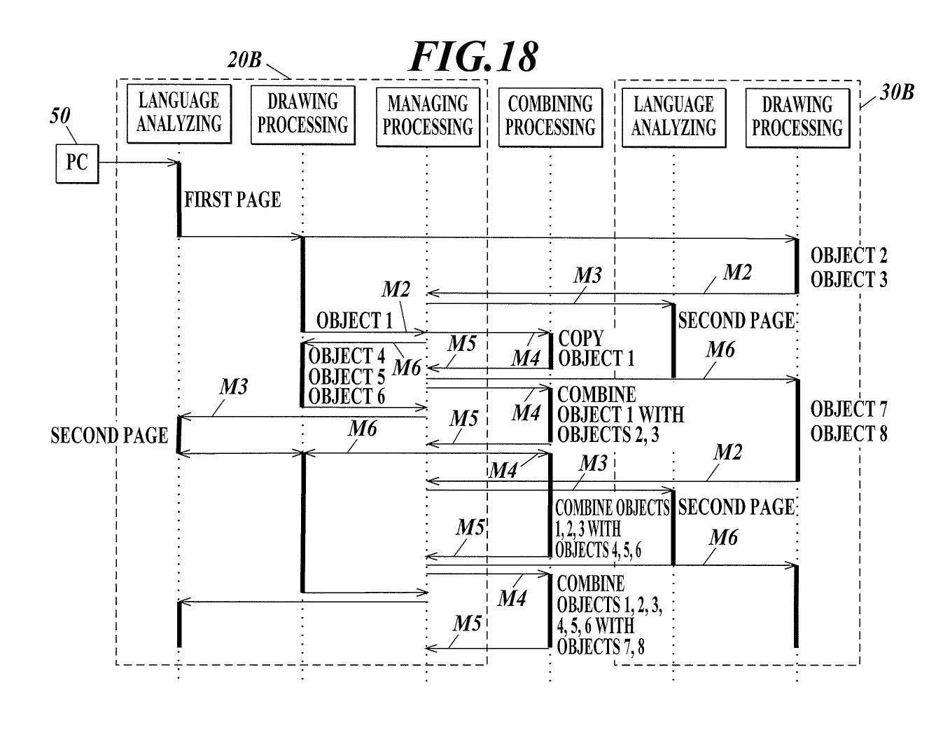

The third embodiment of the present invention is described with reference to FIG. 17 and FIG. 18. First, the configuration of the apparatus of the present embodiment is described with reference to FIG. 17. FIG. 17 is a diagram showing a functional configuration of the image forming apparatus 100B of the present embodiment.

The image forming apparatus 100B is an image forming apparatus compliant to PDL. The image forming apparatus 100B is an apparatus to form (print) an image on a sheet based on print data which is PDL data received from an external input apparatus such as a PC, etc. Here, the image forming apparatus 100B is a printer, however the present invention is not limited to this, and other image forming apparatuses can be applied such as a MFP, etc. Moreover, in the image forming apparatus 100B, the same reference numerals are applied to the sections which are the same as the image forming apparatus 100 of the first embodiment, and the description is omitted.

The image forming apparatus 100B includes a CPU 11B as a control section, a RAM 12, a HDD 13, a ROM 14B, an input I/F section 15, an image forming section 16 and a hardware accelerator 17.

As shown in FIG. 17, the CPU 11B, the RAM 12, the HDD 13, the ROM 14B, the input I/F section 15 and an output I/F section (not shown) can be configured as an image processing apparatus 100γ as a printer controller. The image processing apparatus 100γ is connected to the image forming apparatus as an external device and transmits generated printable data with the output I/F section to the image forming apparatus and forms (prints) an image on a sheet.

The CPU 11B controls each section of the image forming apparatus 100B. The CPU 11B is a dual core processor including cores 20B, 30B as a computing section. The CPU 11B (cores 20B, 30B) reads out a program from the ROM 14B and expands the program in the RAM 12 as necessary, and in coordination with the program, performs various processing. Specifically, in coordination with a language analyzing processing program read out from the ROM 14B, the core 20B functions as a language analyzing processing section 21B. In coordination with a third drawing processing program read out from the ROM 14B, the core 20B functions as a drawing processing section 22B. In coordination with a managing program read out from the ROM 14B, the core 20B functions as a managing section 24B.

Moreover, in coordination with a language analyzing processing program read out from the ROM 14B, the core 30B functions as a language analyzing processing section 31B. In coordination with a fourth drawing processing program read out from the ROM 14B, the core 30B functions as a drawing processing section 32B.

Also, in the core 20B, the language analyzing processing section 21B and the drawing processing section 22B operate in a time sequence, and only one operates at one time. Moreover, in the core 20B, the language analyzing processing section 21B or the drawing processing section 22B operate simultaneously with the managing section 24B in a time sequence. In the core 30B, the language analyzing processing section 31B and the drawing processing section 32B operate in a time sequence, and only one operates at one time.

The ROM 14B is a read only memory and stores various data such as various programs, font data, etc. Specifically, the ROM 14B stores the language analyzing program, the third drawing processing program, the fourth drawing processing program, the second combining processing program and the managing program.

The hardware accelerator 17 is hardware such as an electronic circuit, etc. to perform rasterizing processing of the DL (display list). The hardware accelerator 17 is embedded in the local RAM 171. The hardware accelerator 17 stores the input DL in the local RAM 171 and rasterizes the DL. The hardware accelerator 17 expands the printable data after rasterizing in the local RAM 171 and stores the data in the RAM 12.

Moreover, the hardware accelerator 17 performs the same operation as the second combining processing shown in FIG. 15. Specifically, when the hardware accelerator 17 receives the message M4 of start of combining processing from the managing section 24B, the hardware accelerator 17 performs the combining processing. After the combining processing is finished, the hardware accelerator 17 notifies the message M5 of request of notification of completion of combining processing to the managing section 24B.

Next, the operation of image forming apparatus 100B is described with reference to FIG. 18. FIG. 18 is a ladder chart showing a language analyzing processing, drawing processing and combining processing performed in the cores 20B, 30B of the image forming apparatus 100B.

The total flow of the image forming processing of the image forming apparatus 1003 is similar to that of the image forming apparatus 100. An example of the operation of the image forming apparatus 100B is described with reference to FIG. 18. As shown in FIG. 18, the image forming apparatus 100B forms an image of the print data input from the PC 50. The image of the print data is mixed with text/line objects (rasterized at a high resolution (1200 dpi)) and objects other than text/line objects (rasterized at a low resolution (600 dpi)).

Also, the core 20B is a core to perform rasterizing at a low resolution (600 dpi). The core 30B is a core to perform rasterizing at a high resolution (1200 dpi). The objects 1, 4, 5, 6 are objects other than text/line objects and the objects 2, 3, 7, 8 are text/line objects. The objects 1 to 8 are objects of the first band of the first page.

First, in the core 20B, the language analyzing processing section 21B performs language analyzing processing on the first page of the print data and generates the DL. After the language analyzing processing of the first page is finished, the drawing processing section 22B rasterizes the object 1 from the generated DL at 600 dpi and expands the object 1 in the memory area of the band for the core 20B in the RAM 12. Also, the drawing processing section 32B rasterizes the objects 2, 3 from the generated DL in order at 1200 dpi, and expands the objects 2, 3 in the memory area of the band for the core 30B in the RAM 12. After the rasterizing of the objects 2, 3, the drawing processing section 32B notifies a message M2 of completion of preparation of combining to the managing section 24B.

Then, in response to the message M2 of completion of preparation of combining from the drawing processing section 32B, the managing section 24B notifies a message M3 of standby of combining to the language analyzing processing section 21B. In response to the message M3 of standby of combining, the language analyzing processing section 31B performs the language analyzing processing of the second page of the print data and generates the DL. Then, after rasterizing the object 1, the drawing processing section 22B notifies the message M2 of completion of preparation of combining to the managing section 24B. Then, in response to the message M2 of completion of preparation of combining from the drawing processing section 22B, the managing section 24B notifies message M4 of start of the combining processing to the hardware accelerator 17. In response to the message M4 of start of the combining processing, the hardware accelerator 17 enlarges the data of the rasterized object 1 to 1200 dpi and combines (copies) the data in the combining area of the RAM 12.

Then, the managing section 24B notifies a message M6 of completion of combining processing to the drawing processing section 22B. In response to the message M6 of completion of combining processing, the drawing processing section 22B rasterizes the objects 4, 5, 6 from the generated DL in order at 600 dpi and expands the objects in the memory area of the band for the core 20B in the RAM 12.

After combining the object 1, the hardware accelerator 17 notifies the message M5 of request of notification of completion of combining processing to the managing section 24B. In response to the message M5 of request of notification of completion of combining processing, the managing section 24B notifies the message M6 of completion of combining processing to the drawing processing section 32B. In response to the message M6 of completion of combining processing, the drawing processing section 32A rasterizes the objects 7, 8 from the generated DL in order at 1200 dpi and expands the objects in the memory area of the band for the core 30B in the RAM 12. Also, the managing section 24B notifies the message M4 of start of combining processing to the hardware accelerator 17. In response to the message M4 of start of combining processing, the hardware accelerator 17 combines the data of the rasterized objects 2, 3 to the data of the object 1 in the combining area of the RAM 12.

After rasterizing the objects 4, 5, 6, the drawing processing section 22B notifies the message M2 of completion of preparation of combining to the managing section 24B. In response to the message M2 of completion of preparation of combining, the managing section 24B notifies the message M3 of standby of combining to the language analyzing processing section 21B. In response to the message M3 of standby of combining, the language analyzing processing section 21B continues the language analyzing processing of the second page of the print data and the DL is generated.

After combining objects 1 to 3, the hardware accelerator 17 notifies the message M5 of request of notification of completion of combining processing to the managing section 24B. In response to the message M5 of request of notification of completion of combining processing, the managing section 24B notifies the message M6 of completion of combining processing to the drawing processing section 22B. Also, the managing section 24B notifies the message M4 of start of combining processing to the hardware accelerator 17. In response to the message M4 of start of combining processing, the hardware accelerator 17 enlarges the data of the rasterized objects 4, 5, 6 to 1200 dpi and the data is combined to the data of objects 1, 2, 3 of the combining area of the RAM 12.

Then, after rasterizing the objects 7, 8, the drawing processing section 32B notifies the message M2 of completion of preparation of combining to the managing section 24B. In response to the message M2 of completion of preparation of combining, the managing section 24B notifies the message M3 of standby of combining to the language analyzing processing section 31B. In response to the message M3 of standby of combining, the language analyzing processing section 31B continues the language analyzing processing of the second page of the print data and generates the DL.

Then, after combining the objects 1 to 6, the hardware accelerator 17 notifies the message M5 of request of notification of completion of combining processing to the managing section 24B. In response to the message M5 of request of notification of completion of combining processing, the managing section 24B notifies the message M6 of completion of combining processing to the drawing processing section 32B. Also, in response to the message M5 of request of notification of completion of combining processing, the managing section 24B notifies the message M4 of start of combining processing to the hardware accelerator 17. In response to the message M4 of the start of the combining processing, the hardware accelerator 17 combines the data of the rasterized objects 7, 8 to the data of the objects 1 to 6 in the combining area in the RAM 12. In this way, the language analyzing processing, drawing processing and combining processing are performed in the cores 20B, 30B.

Here, the operation of the cores 20B, 30B is described in detail. The language analyzing processing performed in the language analyzing processing sections 21B, 31B is similar to the language analyzing processing described in the second embodiment. The drawing processing performed in the drawing processing sections 22B, 32B is similar to the second and third drawing processing performed in the second embodiment. The managing processing performed in the managing section 24B is similar to the managing processing of the second embodiment. However, the combining processing section of the second embodiment is to be the hardware accelerator 17, and in step S97 of the managing processing, the message M6 of completion of combining processing (start of combining processing) is notified to the drawing processing section 22B at the time of the start of the first combining processing. Also, in step S98 of the managing section, the message received in step S91 is the message M5 of request of notification of completion of combining processing, and the managing section 24B notifies the message M6 of completion of combining processing to the drawing processing section of the core different from the core of the drawing processing section which rasterized the object with the largest number on which the combining processing is finished.

According to the above described embodiment, the image forming apparatus 100B includes a hardware accelerator 17 and a CPU 11B including cores 20B, 30B, and the cores 20B, 30B each perform language analyzing processing and drawing processing, and the core 20B performs managing processing to generate printable data based on PDL data (print data). Each of the cores 20B, 30B is set to either one of the two types of resolutions for rasterizing. Specifically, the resolution of the core 20B is set to 600 dpi. The resolution of the core 30B is set to 1200 dpi. The rasterizing of the drawing processing in the cores 20B, 30B are performed in parallel in each core 20B, 30B at the resolution set in each core 20B, 30B. The managing processing manages performing of the language analyzing processing and the third and fourth drawing processing, and the hardware accelerator 17 combines the rasterized object. In the hardware accelerator 17, the data of the object after rasterizing with the low resolution (600 dpi) is enlarged to the highest resolution (1200 dpi) and combined.

Therefore, the image processing of the PDL data can be performed at a high speed and high definition image forming can be realized. Also, the storage area of the RAM 12 used in the combining processing of the core 20B can be made small. Moreover, the managing processing enables managing of the language analyzing processing, the third and fourth drawing processing, and the second combining processing by the hardware accelerator 17 to be performed appropriately. Moreover, the hardware accelerator 17 can perform the combining processing faster than the software processing.

The description of the above described embodiments are an example of a suitable image processing apparatus and image forming apparatus of the present invention, and the invention is not limited to the above.

In the above described embodiments, the CPU has a configuration including two cores as a computing section, however, the configuration is not limited to this. The CPU can be a configuration including three or more cores.

Moreover, the above described embodiments are a configuration in which the hardware accelerator 17 is embedded in the local RAM 171, however, the configuration is not limited to this. The hardware accelerator 17 can be a configuration which uses a RAM 12 or other memory to perform rasterizing of the obtained DL.

Also, the above described embodiments are a configuration in which the managing processing (managing sections 24A, 24B) is performed in the cores 20A, 20B, however, the configuration is not limited to this. For example, the configuration in which the managing processing is performed in the cores 30A, 30B is possible. Further, in a multi-core CPU including three or more cores, a configuration is possible in which the managing processing, the language analyzing processing and the drawing processing are performed in a core different from the actor of performing.

The detailed configuration and the detailed operation of each section composing the image forming apparatuses 100, 100A, 100B of the above described embodiments can be appropriately modified without leaving the scope of the present invention.

Although various exemplary embodiments have been shown and described, the invention is not limited to the embodiments shown. Therefore, the scope of the invention is intended to be limited solely by the scope of the claims that follow and not by the above explanation, and it is intended that the present invention covers modifications and variations that come within the scope of the appended claims and their equivalents.

According to an aspect of the preferred embodiments of the present invention, there is provided an image processing apparatus including:

a control section including a plurality of computing sections, each of the plurality of computing sections to perform language analyzing processing to perform language analysis on PDL data to generate a display list of an object, drawing processing to rasterize an object of the display list, and combining processing to combine data of the rasterized object, to generate printable data based on the PDL data, wherein

each of the plurality of computing sections is set to any one of two or more resolutions for rasterizing;

the rasterizing in the drawing processing is performed parallel in each of the computing sections at the resolutions set in each computing section; and

the combining processing enlarges the data of the rasterized object of a low resolution to the highest resolution and combines the data.

Preferably, in the image processing apparatus, the control section performs managing processing in which one of the plurality of computing sections manages performing of the language analyzing processing, the drawing processing and the combining processing.

Preferably, in the image processing apparatus, a text/line object is rasterized at a high resolution and an object other than a text/line object is rasterized at a low resolution in the drawing processing.

Preferably, in the image processing apparatus, each piece of data of the object rasterized at each resolution is combined in an order of overlapping in the combining processing.

According to another aspect of the preferred embodiments of the present invention, there is provided an image forming apparatus including:

an image processing apparatus including:
a control section including a plurality of computing sections, each of the plurality of computing sections to perform language analyzing processing to perform language analysis on PDL data to generate a display list of an object, drawing processing to rasterize an object of the display list, and combining processing to combine data of the rasterized object, to generate printable data based on the PDL data, wherein
each of the plurality of computing sections is set to any one of two or more resolutions for rasterizing;
the rasterizing in the drawing processing is performed parallel in each of the computing sections at the resolutions set in each computing section; and
the combining processing enlarges the data of the rasterized object of a low resolution to the highest resolution and combines the data; and

an image forming section to perform image forming on a sheet according to printable data generated by the drawing processing.

According to another aspect of the preferred embodiments of the present invention, there is provided an image processing apparatus including:

a hardware accelerator to combine data of a rasterized object; and

a control section including a plurality of computing sections, each of the plurality of computing sections to perform language analyzing processing to perform language analysis on PDL data to generate a display list of an object and drawing processing to rasterize an object of the display list, and either one of the plurality of computing sections performs managing processing to manage the performing of the language analyzing processing and the drawing processing and to allow the hardware accelerator to perform combining processing of the data of the rasterized object, to generate printable data based on the PDL data, wherein

each of the plurality of computing sections is set to any one of two or more resolutions for rasterizing;

the rasterizing in the drawing processing is performed parallel in each of the computing sections at the resolutions set in each computing section; and

the hardware accelerator enlarges the data of the rasterized object of a low resolution to the highest resolution and combines the data.

Preferably, in the image processing apparatus, a text/line object is rasterized at a high resolution and an object other than a text/line object is rasterized at a low resolution in the drawing processing.

Preferably, in the image processing apparatus, each piece of data of the object rasterized at each resolution is combined in an order of overlapping in the combining processing.

According to another aspect of the preferred embodiments of the present invention, there is provided an image forming apparatus including:

an image processing apparatus including:
a hardware accelerator to combine data of a rasterized object; and
a control section including a plurality of computing sections, each of the plurality of computing sections to perform language analyzing processing to perform language analysis on PDL data to generate a display list of an object and drawing processing to rasterize an object of the display list, and either one of the plurality of computing sections performs managing processing to manage the performing of the language analyzing processing and the drawing processing and to allow the hardware accelerator to perform combining processing of the data of the rasterized object, to generate printable data based on the PDL data, wherein
each of the plurality of computing sections is set to any one of two or more resolutions for rasterizing;
the rasterizing in the drawing processing is performed parallel in each of the computing sections at the resolutions set in each computing section; and
the hardware accelerator enlarges the data of the rasterized object of a low resolution to the highest resolution and combines the data; and

an image forming section to perform image forming on a sheet according to printable data generated by the drawing processing.

What is claimed is:

1. An image processing apparatus comprising:
a control section including a plurality of computing sections, each of the plurality of computing sections to perform language analyzing processing to perform language analysis on PDL data to generate a display list of objects, drawing processing to rasterize the object of the display list, and combining processing to combine data of the rasterized objects, to generate printable data based on the PDL data, wherein
each of the plurality of computing sections is set to any one of two or more resolutions for rasterizing;
the rasterizing in the drawing processing is performed parallel in each of the computing sections at the resolutions set in each computing section; and
the combining processing enlarges the data of the rasterized object of a low resolution to the highest resolution and combines the data.

2. The image processing apparatus of claim 1 wherein the control section performs managing processing in which one of the plurality of computing sections manages performing of the language analyzing processing, the drawing processing and the combining processing.

3. The image processing apparatus of claim 1, wherein a text/line object is rasterized at a high resolution and an object other than a text/line object is rasterized at a low resolution in the drawing processing.

4. The image processing apparatus of claim 1, wherein pieces of data of the objects which are rasterized at the respective resolutions are combined one another in an order of overlapping in the combining processing.

5. An image forming apparatus comprising:
an image processing apparatus of claim 1; and
an image forming section to perform image forming on a sheet according to printable data generated by the drawing processing.

6. An image processing apparatus comprising:
a hardware accelerator to combine data of a rasterized object; and
a control section including a plurality of computing sections, each of the plurality of computing sections to perform language analyzing processing to perform language analysis on PDL data to generate a display list of objects and drawing processing to rasterize the objects of the display list, and either one of the plurality of computing sections performs managing processing to manage the performing of the language analyzing processing and the drawing processing and to allow the hardware accelerator to perform combining processing of the data of the rasterized objects, to generate printable data based on the PDL data, wherein
each of the plurality of computing sections is set to any one of two or more resolutions for rasterizing;
the rasterizing in the drawing processing is performed parallel in each of the computing sections at the resolutions set in each computing section; and
the hardware accelerator enlarges the data of the rasterized object of a low resolution to the highest resolution and combines the data.

7. The image processing apparatus of claim 6, wherein a text/line object is rasterized at a high resolution and an object other than a text/line object is rasterized at a low resolution in the drawing processing.

8. The image processing apparatus of claim 6, wherein each piece of data of the object rasterized at each resolution is combined in an order of overlapping in the combining processing.

9. An image forming apparatus comprising:
an image processing apparatus of claim 6; and
an image forming section to perform image forming on a sheet according to printable data generated by the drawing processing.
